(19) United States
(12) Patent Application Publication
(10) Pub. No.: US 2003/0030838 A1
(43) Pub. Date: Feb. 13, 2003

(54) Order control system

(76) Inventor: Juliet Marr, Driffield (GB)

Correspondence Address: Thomas M. Wozny, ANDRUS, SCEALES, STARKE & SAWALL, LLP, Suite 1100, 100 East Wisconsin Avenue, Milwaukee, WI, 53202-4178, US

(21) Appl. No.: 09/924,144

(22) Filed: Aug. 7, 2001

(51) Int. Cl. B41J 1/00; G06F 15/00

(52) U.S. Cl. 358/1.15

(57) ABSTRACT

A print order management system comprises a display for displaying data and prompt information to a user. A data receiver receives, in use, data from a user relating to the desire for the user to obtain information with respect to a print material supplier, or the nature of a print material. A memory stores, in an associated manner, data related at least to the nature of one or more types of print material and one or more suppliers, and a display data generator generates, based upon the input of the user and the data stored in the memory display data representing information to be provided to a user and providing it to the display.

This invention relates to an order control system and, more particularly, to an order control system for controlling the ordering of print material.

Management and storage of the data and documentation associated with the ordering and supply of print material is complex. It is necessary for a manager of such print material to be aware of the material that is in stock, to know who supplies what particular material, the expense of such material, the exact nature of such material (so that it can be updated or amended as required), as well as to be aware of the costs associated with ordering such material and the time required to receive such a material once an order has been submitted to an outside supplier. Accordingly, a person managing the supply of such material within an organisation needs a considerable amount of specialised and particular knowledge in order to ensure effective and efficient supply of such material to the organisation in question. The acquisition of such knowledge can be difficult to achieve, and if there is a turnover of staff then it can be difficult for an organisation to maintain the necessary information in a simple and effective manner. Furthermore, it can be difficult for the manager of such a supply to track multiple orders from different suppliers in addition to ensuring that correct data is provided to suppliers, and that erroneous orders with incorrect data are not provided to a supplier, so that wasted orders are not generated and costs kept to a minimum.

In addition, it is difficult for a supply manager to be aware of the costs associated with submitting a small-quantity order as opposed to a large-quantity one and to determine, dependent upon the nature of the order and the supplier, the most cost effective and time-efficient nature of an order.

Accordingly, there is a need for a system which can support a print order manager to enable both time efficient and cost effective ordering to be performed without excessive expert knowledge of print ordering systems and individual suppliers.

The present invention provides a print order management system comprising:

a display for displaying data and prompt information to a user;

a data receiver for receiving, in use, data from a user relating to the desire for the user to obtain information with respect to a print material supplier, or the nature of a print material;

a memory for storing, in an associated manner, data related at least to the nature of one or more types of print material and one or more suppliers; and

a display data generator for generating, based upon the input of the user and the data stored in the memory display data representing information to be provided to a user and providing it to the display.

By enabling a user to select from the system of the invention data related to a product or a supplier and storing such data in an associated manner it is possible for a user to obtain in an intuitive manner information in relation to a specific print product such as a particular order associated therewith. Furthermore, by providing the ability for an end user to select supplier data information in relation to particular suppliers can be accessed readily, with such information including details of particular print material provided by a supplier, the cost thereof, as well as optionally information related to deadlines that the supplier should be meeting as well as likely order time for new orders.

As the system of the invention optionally also provides for diarying of orders, the creation of new jobs and new print material product data (including specific information as to the layout of the print material and the data that it contains). It is also possible to provide, in a flexible manner, information that can be updated simply and effectively as well as information that can be produced in a simple and straightforward report manner that is capable of being understood even by an untrained user.

An example of the present invention will now be described with reference to the accompanying drawings, in which:

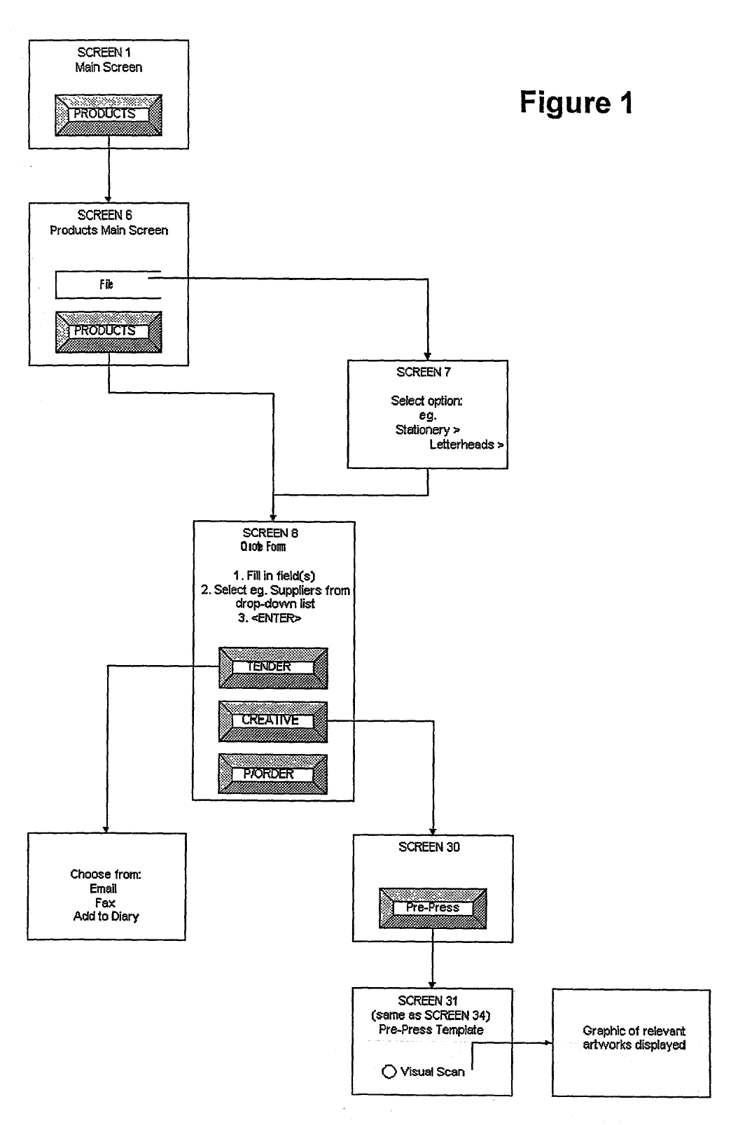

FIG. 1 is a flow diagram showing the operation of the product function of the system of the invention;

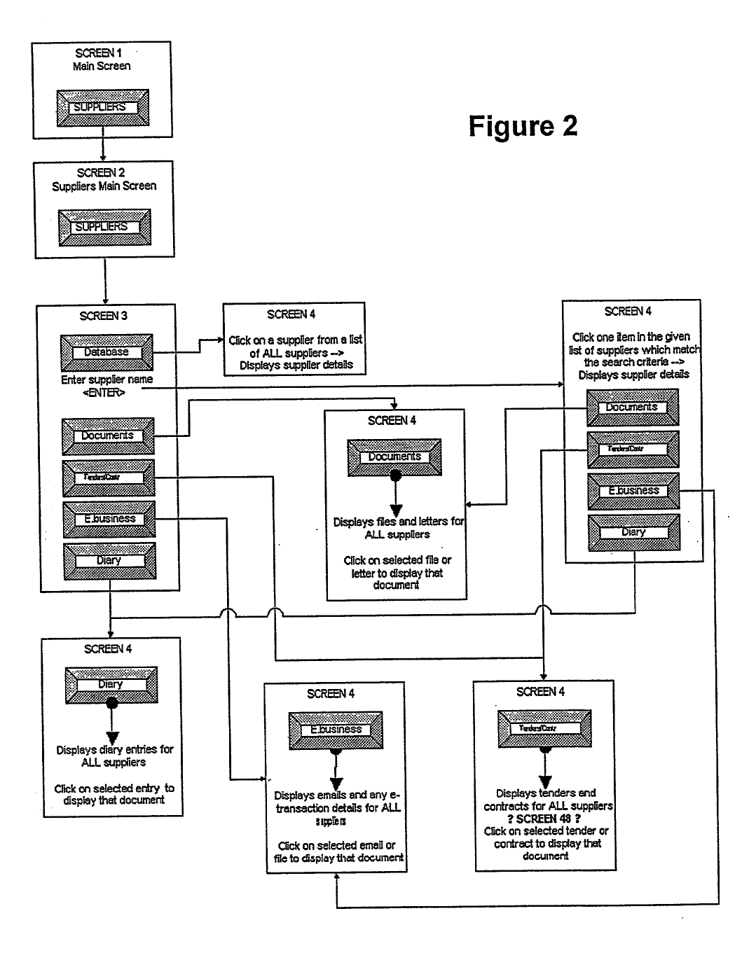

FIG. 2 is a flow diagram showing the operation of a supplier function of the present invention;

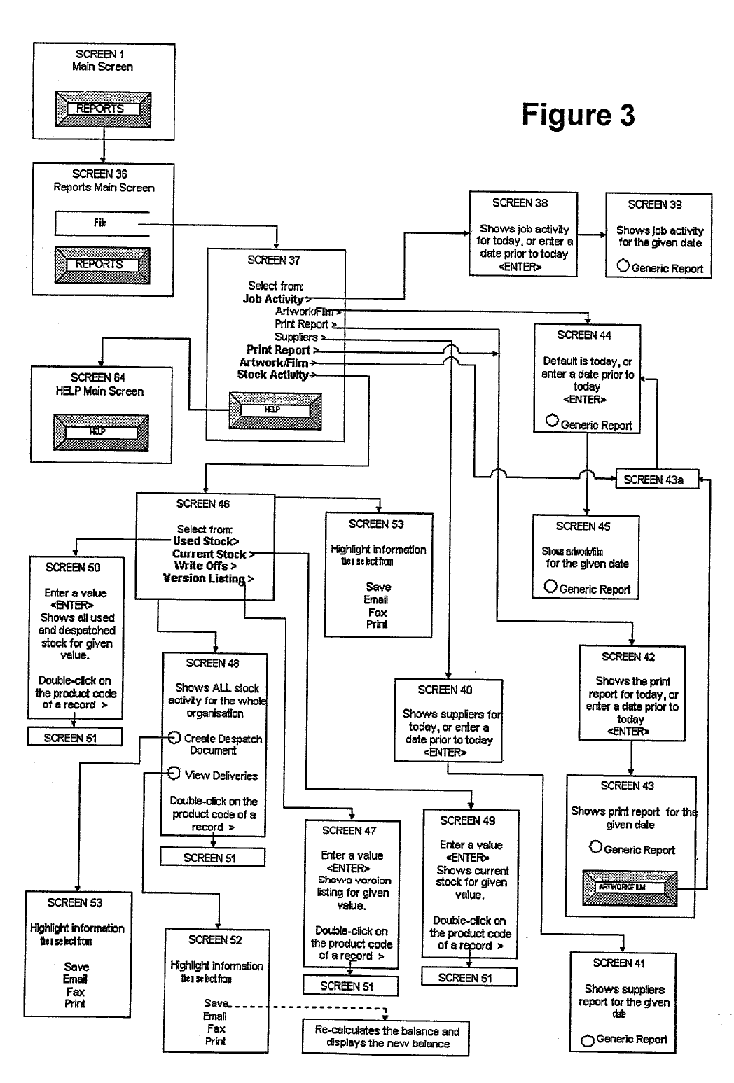

FIG. 3 is a flow diagram showing the operation of the reports function of the present invention;

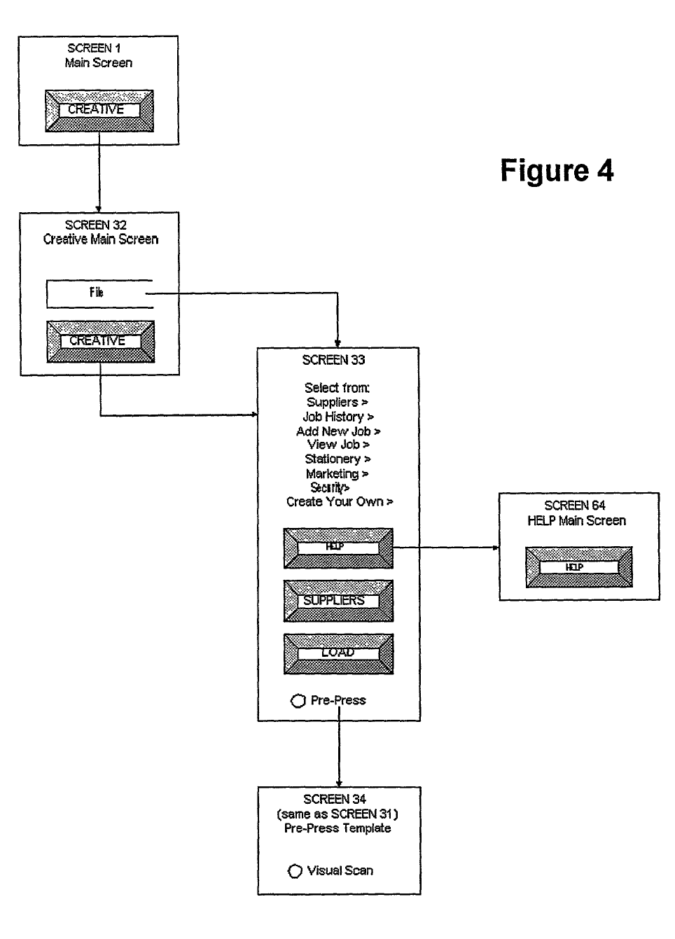

FIG. 4 is a flow diagram showing the creative function of the system of the present invention; and

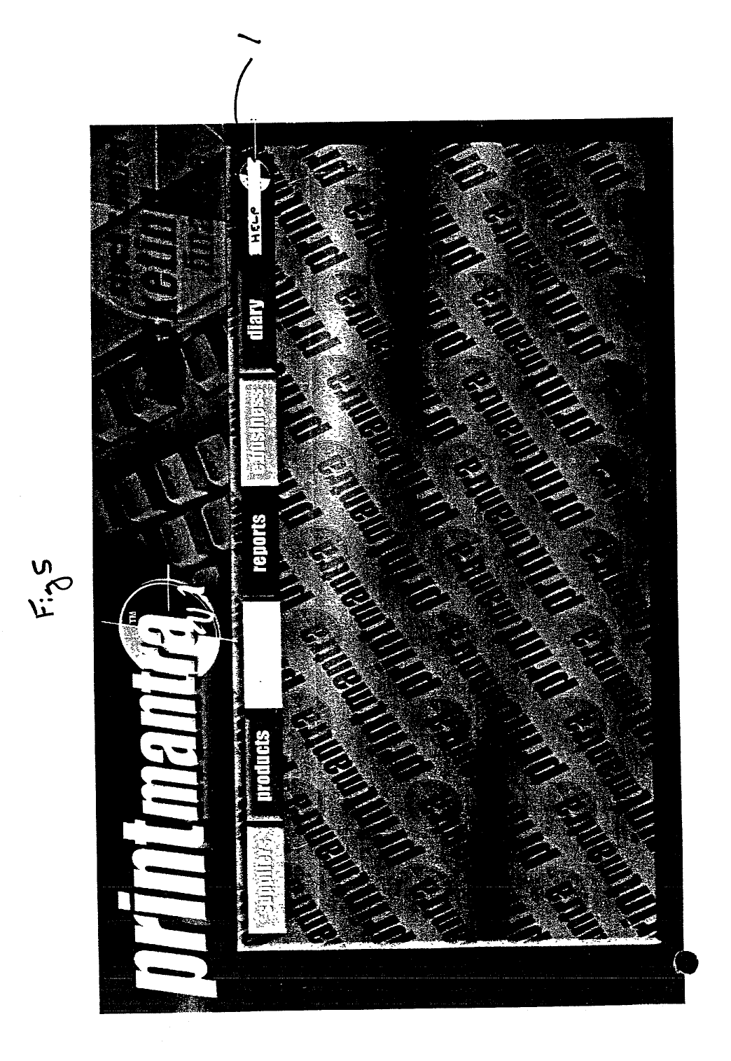

FIG. 5 is a screen dump showing a display screen provided by a system according to the invention.

FIG. 5 shows an example main menu screen provided by a system according to the present invention. The system may be provided by software on an appropriately configured personal computer or Macintosh™ or other appropriately configured computer that may be stand-alone or configured to operate as part of a network.

As can be seen from FIG. 5 the system provides a number of icons 1 which can be selected by a user to access various components of the system to perform certain operation and to provide overall management of a print ordering and supply system for an organisation. The end-user selects whichever icon 1 is appropriate during overall management. There is a help icon to assist the user with operation of the system so that the system can be operated with minimal training. The help function can be stand-alone or context sensitive. There is also an e-business icon which enables the user to communicate with other computers connected to the system or externally via a dedicated connection, e-mail connection, fax connection or similar. There is a diary icon which provides a calender and diary function and which also provides access to diaried information created by the system in a manner that will be discussed below.

The example system also has four further key selectable icons: suppliers, products, creative and reports. By selecting one of these icons a user can enter the system and use it as described below to create new orders, monitor current orders, re-order, and access supplier and product information to manage a print order.

Referring to FIG. 1, a schematic diagram is shown which shows the flow of operation of the system if a user selects the “products” icon from the main screen of FIG. 5. The screen numbers referred to in this figure and FIGS. 2 to 4 are screens that the system displays to an end-user and which, in this example, are configured to have a similar “look and feel” to that of the screen shown in FIG. 5. By selecting the products icon, differing screens (which are not all shown, for the sake of brevity) can be selected in turn to create and obtain information in relation to various products for which orders are to be created or for which orders have been created in the past. By selection of the products icon a user is able to operate the system to select types of product (via screen 7) and/or submit a quote request to a supplier by referencing across to a list of suppliers on screen 4 (which can be edited), selecting them for tender, and choosing to contact them by e-mail or fax or other means. It is also possible for a user to create (via screen 30) a new product and to store the new creation and/or provide details to a supplier for a tender. It is also possible to check a date on which orders are to be met by cross reference to the diary and to see orders for particular products and/or current supplies of particular products. As will be appreciated with reference to FIG. 1, there are many possible routes that a user can select through the products section.

Referring to FIG. 2, a further option possible by selection of the appropriate icon 1 from the main menu screen of the FIG. 5 is that of “suppliers”. By selection of the suppliers icon a screen providing details of suppliers is provided to an end-user and the end-user can then obtain and update supplier details through the selection of further icons. As with the producers function there is also the ability to cross reference to other components of the system, such as the diary function, to provide information in relation to when suppliers were last contacted, if suppliers have outstanding order, etc. Within this function there is also the ability to bring up prior correspondence documentation for particular suppliers, as well as the ability to generate, via by e-business functionality of the system, new correspondence with a selected supplier.

FIG. 3 shows the flow of the “reports” function of the system when this is selected by operating the reports icon on the system main screen. The reports function is generally used not to generate re-writable information, but is arranged to allow an end-user to generate reports relating to the type of documents that have been ordered, stock activity, job activity, as well as the efficiency and cost effectiveness of suppliers and date-related documentation. As with all the functions of the system, there is the ability to access a help option so that an end-user can obtain additional information without reference to external paperwork in respect of how to generate particular reports, the terminology used in the system, etc. This enables the system to be much more user-friendly and to require much less training prior to use than known systems do.

FIG. 4 shows the “creative function” that can be selected, again from the main screen of the type shown in FIG. 5. Again, the creative function is configured to enable cross-reference to the other function and enables the system to provide a document creation aspect that is simple to use, as well as providing the ability for an end-user to adapt the system to their specific requirements in terms of presentation of supplier information, product information, etc.

As can be seen from above, the system of the present invention enables, in a simple and cost-effective manner, an end-user to select information when relating to print ordering in an intuitive manner, yet in a manner which is also flexible in terms of the point of access, be it via supplier information, product information, contact details or even up-coming deadline data. This therefore provides a system which overcomes the inflexibility of prior-art.

1. A print order management system comprising:
a display for displaying data and prompt information to a user;
a data receiver for receiving, in use, data from a user relating to the desire for the user to obtain information with respect to a print material supplier, or the nature of a print material;
a memory for storing, in an associated manner, data related at least to the nature of one or more types of print material and one or more suppliers; and
a display data generator for generating, based upon the input of the user and the data stored in the memory display data representing information to be provided to a user and providing it to the display.

2. A system according to claim 1, wherein the data receiver is also arranged to receive input, in use, from a user in relation to the desire for the user to create a new print order, or generate a report in respect of print orders, and wherein the display data generator also generates display data in respect of the creation of a created job or desired report dependent upon the user input.

3. A system according to claim 1, wherein the data receiver also receives data indicative of a user requiring access to a help database; and further comprising
a help database for providing help data to the display data generator for output to the printer upon receipt of a help request input.

4. A system according to claim 1, further comprising a memory update data receiver for receiving, in use, data from a user relating to at least one of supplier and print material information and forwarding it to the memory.

5. A system according to claim 1, further comprising a diary generator, the diary generator receiving data from the memory and generating a diary based upon the received data and a current date.

6. A system according to claim 5, wherein the data receiver also receives, in use, data relating to the desire for a user to select a diary option.

7. A computer program comprising instruction code for configuring a computer to provide a system according to claim 1.
